(19) United States
(12) Patent Application Publication
(10) Pub. No.: US 2012/0070661 A1
(43) Pub. Date: Mar. 22, 2012

(54) PRESSURE-SENSITIVE ADHESIVE TAPE

(75) Inventors: Shinsuke IKISHIMA, Ibaraki-shi (JP); Takashi HABU, Ibaraki-shi (JP); Fumiteru ASAI, Ibaraki-shi (JP); Kooki OOYAMA, Ibaraki-shi (JP); Tadao TORII, Ibaraki-shi (JP); Katsutoshi KAMEI, Ibaraki-shi (JP); Yuuki KATOU, Ibaraki-shi (JP); Tomokazu TAKAHASHI, Ibaraki-shi (JP)

(73) Assignee: NITTO DENKO CORPORATION, Osaka (JP)

(21) Appl. No.: 13/232,476

(22) Filed: Sep. 14, 2011

(30) Foreign Application Priority Data
Sep. 16, 2010 (JP) 2010-207827

(51) Int. Cl. C09J 7/02; B29C 47/06; C09J 123/14; B32B 27/08

(52) U.S. Cl. 428/355 EN; 264/173.19

(57) ABSTRACT

A pressure-sensitive adhesive tape according to an embodiment of the present invention includes,
a pressure-sensitive adhesive layer; and
a base layer, wherein:
the pressure-sensitive adhesive layer contains an amorphous propylene- (1-butene) copolymer polymerized by using a metallocene catalyst, the amorphous propylene-(1-butene) copolymer having a weight-average molecular weight (Mw) of 200,000 or more and a molecular weight distribution (Mw/Mn) of 2 or less; and
the base layer contains an ethylene-vinyl acetate copolymer.

This application claims priority under 35 U.S.C. Section 119 to Japanese Patent Application No. 2010-207827 filed on Sep. 16, 2010, which are herein incorporated by references.

### BACKGROUND OF THE INVENTION

1. Field of the Invention

The present invention relates to a pressure-sensitive adhesive tape.

2. Description of the Related Art

A semiconductor wafer formed of silicon, gallium, or arsenic is produced as a large-diameter product, and a pattern is formed on its front face. Then, the back face is ground to reduce the thickness of the wafer to usually about 100 to 600 μm, and the wafer is cut and separated into element pieces (dicing), followed by a mounting step.

In the step of grinding the back face of the semiconductor wafer (back face-grinding step), a pressure-sensitive adhesive tape is used to protect the pattern surface of the semiconductor wafer. The pressure-sensitive adhesive tape is usually peeled off after the back face-grinding step. The pressure-sensitive adhesive tape used for such purpose is required to have an adhesion enough not to peel off during the back face-grinding step but is required to have a low adhesion so that the tape is easily peeled off after the back face-grinding step and does not to break the semiconductor wafer.

Conventionally, as such pressure-sensitive adhesive tape, a pressure-sensitive adhesive tape including a base material coated with a pressure-sensitive adhesive has been used. For example, there has been proposed a pressure-sensitive adhesive tape including a pressure-sensitive adhesive layer obtained by applying an acrylic pressure-sensitive adhesive on a base material containing a polyethylene-based resin (WO2007/116856). However, the production of such pressure-sensitive adhesive tape requires many steps such as the step of forming the base material into a film and the step of applying a pressure-sensitive adhesive solution, and hence the tape is expensive to produce. Moreover, there is a problem of a large amount of exhaust CO₂. In addition, in the above-mentioned production method, it is necessary to remove an organic solvent after application of the pressure-sensitive adhesive solution by drying, and hence there is a problem of an environmental burden due to volatilization of the organic solvent.

As a method of solving such problems, there is given a method including performing coextrusion of a base material-forming material and a pressure-sensitive adhesive-forming material. However, materials which may be subjected to the coextrusion are thermoplastic resins, and in the case of using a thermoplastic acrylic resin, a thermoplastic styrene-based resin, or the like as the pressure-sensitive adhesive-forming material, there is a problem in that an impurity derived from the pressure-sensitive adhesive may contaminate the semiconductor wafer. In particular, when an ion generated in polymerization of a resin for constructing the pressure-sensitive adhesive (for example, an ion derived from a catalyst) remains in the pressure-sensitive adhesive layer and contaminates a wafer circuit, a trouble such as disconnection or short of the circuit may be caused.

### SUMMARY OF THE INVENTION

The present invention has been made to solve the above-mentioned conventional problems, and an object of the present invention is to provide a pressure-sensitive adhesive tape which causes less contamination to an adherend, is excellent in both adhesion and peeling property, and can be produced by coextrusion molding.

A pressure-sensitive adhesive tape according to an embodiment of the present invention includes,

a pressure-sensitive adhesive layer; and

a base layer, wherein:

the pressure-sensitive adhesive layer contains an amorphous propylene-(1-butene) copolymer polymerized by using a metallocene catalyst, the amorphous propylene-(1-butene) copolymer having a weight-average molecular weight (Mw) of 200,000 or more and a molecular weight distribution (Mw/Mn) of 2 or less; and

the base layer contains an ethylene-vinyl acetate copolymer.

In a preferred embodiment of the present invention, the pressure-sensitive adhesive layer is substantially free of F⁻, Cl⁻, Br⁻, NO₂⁻, NO₃⁻, SO₄²⁻, Li⁺, Na⁺, K⁺, Mg²⁺, Ca²⁺, and NH₄⁺.

In a preferred embodiment of the present invention, a content of a constituent unit derived from 1-butene in the propylene-(1-butene) copolymer is 1 mol % to 15 mol %.

In a preferred embodiment of the present invention, the pressure-sensitive adhesive tape is obtained by coextrusion molding of a pressure-sensitive adhesive layer-forming material and a base layer-forming material.

In a preferred embodiment of the present invention, a difference “pressure-sensitive adhesive layer-forming material-base layer-forming material” in shear viscosity of the pressure-sensitive adhesive layer-forming material and the base layer-forming material at a temperature of 180° C. and a shear rate of 100 sec⁻¹ is −150 Pa·s to 600 Pa·s or less.

In a preferred embodiment of the present invention, the pressure-sensitive adhesive tape is used for processing a semiconductor wafer.

According to the present invention, it is possible to provide a pressure-sensitive adhesive tape which causes less contamination to an adherend and is excellent in both adhesion and peeling property because the tape includes the pressure-sensitive adhesive layer containing a specific copolymer. Such pressure-sensitive adhesive tape is particularly suitable as a pressure-sensitive adhesive tape for processing a semiconductor wafer. Moreover, according to the present invention, it is possible to provide a pressure-sensitive adhesive tape which can be produced in few steps without using an organic solvent because the tape is produced by coextrusion molding.

### BRIEF DESCRIPTION OF THE DRAWINGS

In the accompanying drawings:

FIG. 1 is a schematic cross-sectional view of a laminated film according a preferred embodiment of the present invention; and

FIG. 2 is a view for describing a “peeling width” used as an index of step following property of a pressure-sensitive adhesive tape of the present invention.

### DETAILED DESCRIPTION OF THE PREFERRED EMBODIMENTS

A. Entire Construction of Pressure-Sensitive Adhesive Tape

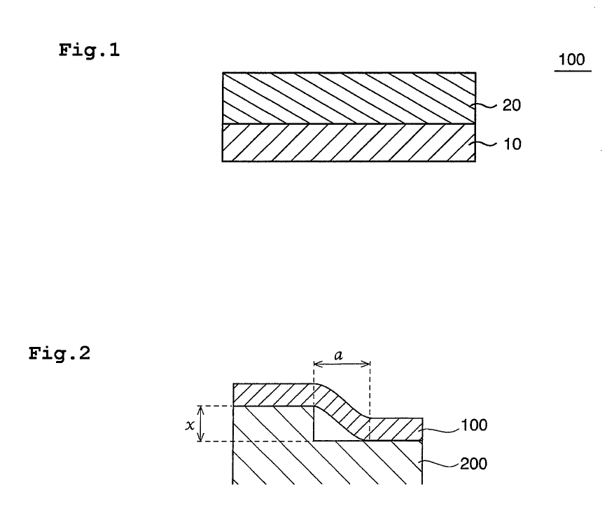

FIG. 1 is a schematic cross-sectional view of a pressure-sensitive adhesive tape according to a preferred embodiment of the present invention. The pressure-sensitive adhesive tape 100 includes a pressure-sensitive adhesive layer 10 and a base layer 20. The pressure-sensitive adhesive layer 10 contains an amorphous propylene-(1-butene) copolymer. The base layer 20 contains an ethylene-vinyl acetate copolymer. The pressure-sensitive adhesive layer 10 and base layer 20 in the pressure-sensitive adhesive tape 100 are preferably formed by coextrusion molding.

The pressure-sensitive adhesive tape 100 has a thickness of preferably 90 μm to 285 μm, more preferably 105 μm to 225 μm, particularly preferably 130 μm to 205 μm.

The pressure-sensitive adhesive layer 10 has a thickness of preferably 20 μm to 100 μm, more preferably 30 μm to 65 μm.

The base layer 20 has a thickness of preferably 30 μm to 185 μm, more preferably 65 μm to 175 μm.

The pressure-sensitive adhesive tape of the present invention may further include any other appropriate layer. Examples of the other layer include a surface layer which is provided on the side opposite to the pressure-sensitive adhesive layer of the base layer and which may impart heat-resistance to the pressure-sensitive adhesive tape.

The pressure-sensitive adhesive tape of the present invention has an adhesion of preferably 0.3 N/20 mm to 3.0 N/20 mm, more preferably 0.4 N/20 mm to 2.5 N/20 mm, particularly preferably 0.4 N/20 mm to 2.0 N/20 mm, which is measured after aging at 50° C. for two days by a method according to JIS Z 0237 (2000) (attaching conditions: turning a 2-kg roller one round, peeling rate: 300 mm/min, peeling angle: 180°) using a semiconductor mirror wafer (made of silicon) as a test plate. If the adhesion is in such range, it is possible to obtain a pressure-sensitive adhesive tape which is excellent in both adhesion and peeling property and hence, for example, does not peel off during grinding processing in the back face-grinding step for a semiconductor wafer and can be easily peeled off after grinding processing. In the present invention, the adhesion can be exhibited by blending the amorphous propylene-(1-butene) copolymer as a major component in the pressure-sensitive adhesive layer and can be adjusted by adding the crystalline polypropylene-based resin. Details of components in the pressure-sensitive adhesive layer are described below.

In the case where the pressure-sensitive adhesive tape of the present invention is attached on the mirror surface of a 4-inch semiconductor wafer and peeled off after a lapse of 1 hour under an environment of a temperature of 23° C. and a relative humidity of 50%, the number of particles each having a particle size of 0.28 μm or more on the mirror surface is preferably 1 particle/cm² to 500 particles/cm², more preferably 1 particle/cm² to 100 particles/cm², particularly preferably 1 particle/cm² to 50 particles/cm², most preferably 0 particle/cm² to 20 particles/cm². The number of particles can be measured by a particle counter. Moreover, in the case where the pressure-sensitive adhesive tape of the present invention is attached on the mirror surface of the semiconductor wafer and peeled off after a lapse of 1 day under an environment of a temperature of 40° C. and a relative humidity of 50%, an increment of carbon atoms on the wafer surface (that is, an amount of organic matter transferred onto the wafer) is preferably 1 atomic % to 45 atomic %, more preferably 1 atomic % to 30 atomic % compared with before attachment of the pressure-sensitive adhesive tape. The amount of carbon atoms on the wafer surface can be measured by electron spectroscopy for chemical analysis (ESCA). Specifically, the increment of carbon atoms on the wafer surface (that is, the amount of organic matter transferred onto the wafer) is calculated by a difference between the amount of carbon atoms on the mirror surface of a semiconductor wafer on which no pressure-sensitive adhesive tape is attached and the amount of carbon atoms on the mirror surface of the semiconductor water after the pressure-sensitive adhesive tape has been attached and peeled off as described above. As an ESCA device, for example, a product manufactured by ULVAC-PHI, INCORPORATED (product name “model 5400”) may be used.

In this specification, a “peeling width” is used as an index of step following property of the pressure-sensitive adhesive tape. As shown in FIG. 2, the term “peeling width” refers to, in the case where a pressure-sensitive adhesive tape 100 is attached on an adherend 200 having a step x, a width a of a part which does not contact with the adherend 200 because the pressure-sensitive adhesive tape is not attached. The peeling width of the pressure-sensitive adhesive tape of the present invention with respect to an adherend having a step of 3.5 μm immediately after attachment is preferably 10 μm to 200 μm, more preferably 20 μm to 180 μm, particularly preferably 30 μm to 150 μm. The pressure-sensitive adhesive tape having a peeling width in such range can follow an adherend having irregularities (for example, irregularities of a semiconductor wafer pattern) well, and in the case where the pressure-sensitive adhesive tape of the present invention is used for processing a semiconductor wafer, it is possible to prevent invasion of grinding water into an interface between the semiconductor wafer and the pressure-sensitive adhesive tape in the back face-grinding step.

In the case where the pressure-sensitive adhesive tape of the present invention is attached on a semiconductor mirror wafer (made of silicon), an increment of the peeling width with respect to a step of 30 μm from immediately after attachment to after a lapse of 24 hours is preferably 40% or less, more preferably 20% or less, particularly preferably 10% or less. A pressure-sensitive adhesive tape which exhibits such increment of the peeling width, that is, a pressure-sensitive adhesive tape which exhibits a small change with time in adhesion is excellent in storage stability and processing stability in production, for example, hardly causing a tape peeling part in a product in process with time in production of a semiconductor wafer.

The pressure-sensitive adhesive tape of the present invention may be provided while being protected with a separator. The pressure-sensitive adhesive tape of the present invention can be wound in a roll shape in a state of being protected with the separator. The separator has a function as a protective material for protecting the pressure-sensitive adhesive tape of the present invention before the tape is put into practical use. Examples of the separator include a plastic (for example, polyethylene terephthalate (PET), polyethylene, or polypropylene) film, nonwoven fabric, and paper whose surfaces are coated with releasing agents such as a silicone-based releasing agent, a fluorine-based releasing agent, and a long-chain alkyl acrylate-based releasing agent.

In, for example, the case where the pressure-sensitive adhesive tape of the present invention is not protected with the separator, the outermost layer on the side opposite to the pressure-sensitive adhesive layer of the tape may be subjected to a back surface treatment. The back surface treatment can be performed with, for example, a releasing agent such as a silicone-based releasing agent or a long-chain alkyl acrylate-based releasing agent. When the pressure-sensitive adhesive tape of the present invention is subjected to the back surface treatment, the tape can be wound in a roll shape.

B. Pressure-Sensitive Adhesive Layer

The above-mentioned pressure-sensitive adhesive layer contains an amorphous propylene-(1-butene) copolymer. If such pressure-sensitive adhesive layer is used, it is possible to produce the pressure-sensitive adhesive tape by coextrusion molding with the base layer in few steps without using an organic solvent. It should be noted that the term “amorphous” as used herein refers to property of not having a clear melting point unlike a crystalline material.

The above-mentioned amorphous propylene-(1-butene) copolymer can be obtained by polymerizing propylene and 1-butene by using a metallocene catalyst. More specifically, the amorphous propylene-(1-butene) copolymer can be obtained by performing, for example: a polymerization step of polymerizing propylene and 1-butene by using the metallocene catalyst; and then after-treatment steps such as the step of removing a catalyst residue and the step of removing foreign matter. The amorphous propylene-(1-butene) copolymer is obtained by such steps in a form of, for example, powder or pellet. Examples of the metallocene catalyst include a metallocene-uniformly-mixed catalyst including a metallocene compound and aluminoxane and a metallocene-carrying catalyst including a metallocene compound carried on a particulate carrier.

The amorphous propylene-(1-butene) copolymer polymerized by using the metallocene catalyst as described above has a narrow molecular weight distribution. Specifically, the above-mentioned amorphous propylene-(1-butene) copolymer has a molecular weight distribution (Mw/Mn) of 2 or less, preferably 1. 1 to 2, more preferably 1.2 to 1.9. An amorphous propylene-(1-butene) copolymer having a narrow molecular weight distribution contains low-molecular-weight components in small amounts. Therefore, when such amorphous propylene-(1-butene) copolymer is used, a pressure-sensitive adhesive tape capable of preventing contamination of an adherend by bleeding of the low-molecular-weight components can be obtained. Such pressure-sensitive adhesive tape is suitably used for processing a semiconductor wafer, for example.

The content of a constituent unit derived from propylene in the above-mentioned amorphous propylene-(1-butene) copolymer is preferably 80 mol % to 99 mol %, more preferably 85 mol % to 99 mol %, particularly preferably 90 mol % to 99 mol %.

The content of a constituent unit derived from 1-butene in the above-mentioned amorphous propylene-(1-butene) copolymer is preferably 1 mol % to 15 mol %, more preferably 1 mol % to 10 mol %. If the contents are in such ranges, a pressure-sensitive adhesive tape which is excellent in a balance between toughness and flexibility and in which the above-mentioned peeling width is small can be obtained.

The above-mentioned amorphous propylene-(1-butene) copolymer may be a block copolymer or a random copolymer.

The above-mentioned amorphous propylene-(1-butene) copolymer has a weight-average molecular weight (Mw) of 200,000 or more, preferably 200, 000 to 500,000, more preferably 200,000 to 300,000. If the weight-average molecular weight (Mw) of the amorphous propylene-(1-butene) copolymer is in such range, it is possible to obtain a pressure-sensitive adhesive tape containing low-molecular-weight components in small amounts and capable of preventing contamination of an adherent compared with general styrene-based thermoplastic resins and acrylic thermoplastic resins (Mw: 100,000 or less). It is further possible to form the pressure-sensitive adhesive layer without processing failures in coextrusion molding and to provide an appropriate adhesion.

The above-mentioned amorphous propylene-(1-butene) copolymer has a melt flow rate at 230° C. and 2.16 kgf of preferably 1 g/10 min to 50 g/10 min, more preferably 5 g/10 min to 30 g/10 min, particularly preferably 5 g/10 min to 20 g/10 min. If the melt flow rate of the amorphous propylene-(1-butene) copolymer is in such range, a pressure-sensitive adhesive layer having a uniform thickness can be formed by coextrusion molding without processing failures. The melt flow rate can be measured by a method according to JIS K 7210.

As long as the effects of the present invention are not impaired, the above-mentioned amorphous propylene-(1-butene) copolymer may also include a constituent unit derived from any other monomer. Examples of other monomer include α-olefins such as ethylene, 1-pentene, 1-hexene, 1-octene, 1-decene, 4-methyl-1-pentene, and 3-methyl-1-pentene.

Preferably, the above-mentioned pressure-sensitive adhesive layer is substantially free of Br⁻, NO₂⁻, NO₃⁻, SO₄²⁻, Li⁺, Na⁺, Mg²⁺, Ca²⁺, and NH₄⁺ because it is possible to prevent contamination of an adherent with such ions. For example, in the case where a pressure-sensitive adhesive tape including such pressure-sensitive adhesive layer is used for processing a semiconductor wafer, disconnection or short of a circuit or the like does not occur. The pressure-sensitive adhesive layer free of the above-mentioned ions can be obtained by, for example, solution polymerization of the amorphous propylene-(1-butene) copolymer in the pressure-sensitive adhesive layer using the metallocene catalyst as described above. In the solution polymerization using the metallocene catalyst, the amorphous propylene-(1-butene) copolymer can be purified by repeating precipitation and isolation (reprecipitation) using a poor solvent different from a solvent used in polymerization, and hence the pressure-sensitive adhesive layer free of the above-mentioned ions can be obtained. It should be noted that, in this specification, the phrase “substantially free of F⁻, Cl⁻, Br^{'1}, NO₂⁻, NO₃⁻, SO₄²⁻, Li⁺, Na⁺, K⁺, Mg²⁺, Ca²⁺, and NH₄⁺” means that concentrations of the ions, measured by a standard ion chromatography analysis (for example, an ion chromatography analysis using a device manufactured by DIONEX, product name “DX-320” or “DX-500”), are lower than detection limits. Specifically, the phrase means that 1 g of the pressure-sensitive adhesive layer contains 0.49 μg or less of each of F⁻, Cl⁻, Br⁻, NO₂⁻, NO₃⁻, SO₄²⁻, and K⁺, 0.20 μg or less of each of Li⁺ and Na⁺, 0.97 μg or less of each of Mg²⁺ and Ca²⁺, and 0.5 μg or less of NH₄⁺.

The storage elastic modulus (G′) of the above-mentioned pressure-sensitive adhesive layer is preferably 0.5×10⁶ Pa to 1.0×10⁸ Pa, more preferably 0.8×106 Pa to 3×10⁷ Pa. If the storage elastic modulus (G′) of the above-mentioned pressure-sensitive adhesive layer is in such range, it is possible to obtain a pressure-sensitive adhesive tape having both a sufficient adhesion and appropriate peeling property for an adherend having irregularities on its surface. Further, in the case where the pressure-sensitive adhesive tape including the above-mentioned pressure-sensitive adhesive layer having such storage elastic modulus (G′) is used for processing a semiconductor wafer, the tape may contribute to achievement of excellent grinding accuracy in grinding of the back face of the wafer. It should be noted that the storage elastic modulus (G′) in the present invention can be measured by dynamic viscoelasticity spectrum measurement.

The above-mentioned pressure-sensitive adhesive layer may contain a crystalline polypropylene-based resin to adjust the adhesion of the pressure-sensitive adhesive layer (as a result, the adhesion of the above-mentioned pressure-sensitive adhesive tape) and the above-mentioned storage elastic modulus. When the pressure-sensitive adhesive layer contains the crystalline polypropylene-based resin, it is possible to decrease the above-mentioned adhesion and to increase the above-mentioned storage elastic modulus. The content of the crystalline polypropylene-based resin may be adjusted to any appropriate ratio depending on the desired adhesion and storage elastic modulus. The content of the crystalline polypropylene-based resin is preferably 0 wt % to 50 wt %, more preferably 0 wt % to 40 wt %, particularly preferably 0 wt % to 30 wt % with respect to the total weight of the above-mentioned amorphous propylene-(1-butene) copolymer and the crystalline polypropylene-based resin.

The above-mentioned crystalline polypropylene-based resin may be homopolypropylene or a copolymer obtained by copolymerizing propylene and a monomer copolymerizable with propylene. Examples of the monomer copolymerizable with propylene include α-olefins such as ethylene, 1-pentene, 1-hexene, 1-octene, 1-decene, 4-methyl-1-pentene, and 3-methyl-1-pentene.

The above-mentioned crystalline polypropylene-based resin is obtained preferably by polymerization using the metallocene catalyst as with the case of the above-mentioned amorphous propylene-(1-butene) copolymer. If the crystalline polypropylene-based resin obtained as described above is used, it is possible to prevent contamination of an adherend due to bleeding of low-molecular-weight components.

The above-mentioned crystalline polypropylene-based resin has a crystallinity of preferably 10% or more, more preferably 20% or more. The crystallinity can be determined typically by differential scanning calorimetry (DSC) or X-ray diffraction.

The above-mentioned pressure-sensitive adhesive layer may further contain any other component as long as the effects of the present invention are not impaired. Examples of the other component include an antioxidant, a UV absorbing agent, a light stabilizer, a heat stabilizer, and an antistat. The type and usage of the other component may be appropriately selected depending on purposes.

C. Base Layer

The above-mentioned base layer contains an ethylene-vinyl acetate copolymer.

The above-mentioned ethylene-vinyl acetate copolymer has a weight-average molecular weight (Mw) of preferably 10,000 to 200,000, more preferably 30,000 to 190,000. If the weight-average molecular weight (Mw) of the ethylene-vinyl acetate copolymer is in such range, it is possible to form the base layer without processing failures in coextrusion molding.

The above-mentioned ethylene-vinyl acetate copolymer has a melt flow rate at 190° C. and 2.16 kgf of preferably 2 g/10 min to 20 g/10 min, more preferably 5 g/10 min to 15 g/10 min, particularly preferably 7 g/10 min to 12 g/10 min. If the melt flow rate of the ethylene-vinyl acetate copolymer is in such range, it is possible to form the base layer without processing failures by coextrusion molding.

The above-mentioned base layer may further contain any other component as long as the effects of the present invention are not impaired. Examples of the other component include the same components as those described in the above-mentioned section B as components which may be contained in the pressure-sensitive adhesive layer.

D. Method of Producing Pressure-Sensitive Adhesive Tape

The pressure-sensitive adhesive tape of the present invention is produced by coextrusion molding of forming materials for the above-mentioned pressure-sensitive adhesive layer and the above-mentioned base layer. The coextrusion molding enables production of a pressure-sensitive adhesive tape having good adhesion property between layers in few steps without using an organic solvent.

In the above-mentioned coextrusion molding, the forming materials for the above-mentioned pressure-sensitive adhesive layer and the above-mentioned base layer may be materials obtained by mixing the above-mentioned components of the respective layers by any appropriate method.

A specific method for the above-mentioned coextrusion molding is, for example, a method including: supplying the pressure-sensitive adhesive layer-forming material and the base layer-forming material separately to different extruders of at least two extruders connected to dies; melting and extruding the materials; and collecting the resultant products by a touch-roll molding method to mold a laminate. In the extrusion, a confluence part of the forming materials is preferably close to outlets of the dies (die slips). This is because such structure can prevent confluence failures of the forming materials in the dies. Therefore, as the above-mentioned dies, multi-manifold-system dies are preferably used. It should be noted that the case where the confluence failures are caused is not preferred because appearance failures due to irregular confluence, specifically, wavelike appearance irregularities between the pressure-sensitive adhesive layer and the base layer extruded are caused. Further, the confluence failures are caused by, for example, a large difference in flowability (melt viscosity) between different forming materials in dies and a large difference in shear rate between the forming materials of the respective layers. Therefore, if the multi-manifold-system dies are used, different materials having a difference in flowability can widely be selected compared with another system (for example, feed-block-system). Screw types of the extruders used in melting of the forming materials may each be monoaxial or biaxial. As the extruders, three or more may be used. In the case of using three or more extruders, a forming material for another layer can further be supplied. Moreover, in the case where a pressure-sensitive adhesive tape of a two-layer structure (base layer+pressure-sensitive adhesive layer) is produced using three or more extruders, the same forming material may be supplied to two or more adjacent extruders. For example, in the case of using three extruders, the same forming material may be supplied to two adjacent extruders.

The molding temperature in the above-mentioned coextrusion molding is preferably 160° C. to 220° C., more preferably 170° C. to 200° C. If the temperature is in such range, excellent molding stability can be achieved.

A difference in shear viscosity between the above-mentioned pressure-sensitive adhesive layer-forming material and the above-mentioned base layer-forming material at a temperature of 180° C. and a shear rate of 100 sec⁻¹ (the pressure-sensitive adhesive layer-forming material-the base layer-forming material) is preferably −150 Pa·s to 600 Pa·s or less, more preferably −100 Pa·s to 550 Pa·s, particularly preferably −50 Pa·s to 500 Pa·s. If the difference is in such range, it is possible to prevent confluence failures because the pressure-sensitive adhesive layer-forming material and the base layer-forming material described above are similar in flowability in dies. It should be noted that the shear viscosity can be measured by a twin capillary extensional rheometer.

### EXAMPLES

Hereinafter, the present invention is described specifically by way of examples. However, the present invention is by no means limited to these examples. It should be noted that in the examples and the like, test and evaluation methods are as described below, and the term “part(s)” means “part(s) by weight.”

### Example 1

An amorphous propylene-(1-butene) copolymer polymerized by using the metallocene catalyst (manufactured by Sumitomo Chemical Co., Ltd., product name “Tafseren H5002”: constituent unit derived from propylene: 90 mol %/constituent unit derived from 1-butene: 10 mol %, Mw=230,000, Mw/Mn=1.8) was used as the pressure-sensitive adhesive layer-forming material.

An ethylene-vinyl acetate copolymer (manufactured by DU PONT-MITSUI POLYCHEMICALS, product name “Evaflex P-1007”) was used as the base layer-forming material.

The pressure-sensitive adhesive layer-forming material (100 parts) and the base layer-forming material (100 parts) described above were separately fed into extruders to perform T-die melt-coextrusion (extruder: manufactured by GM ENGINEERING, Inc., product name “GM 30-28”/T-die: feed-block system; extrusion temperature: 180° C.), and the molten resins and an Si-coated PET separator (manufactured by Mitsubishi Chemical Corporation, product name “Diafoil MRF”: 38 μm), which was delivered to a touch roll molding part, were laminated, followed by cooling, to thereby obtain a pressure-sensitive adhesive tape including a pressure-sensitive adhesive layer with a thickness of 30 μm and a base layer with a thickness of 100 μm. It should be noted that the thickness of each layer was controlled by the shape of the outlet of the T-die.

### Example 2

A pressure-sensitive adhesive tape was obtained in the same manner as in Example 1 except that the thickness of the pressure-sensitive adhesive layer was changed to 45 μm, and the thickness of the base layer was changed to 85 μm.

### Example 3

A pressure-sensitive adhesive tape was obtained in the same manner as in Example 1 except that the thickness of the base layer was changed to 175 μm.

### Example 4

A pressure-sensitive adhesive tape was obtained in the same manner as in Example 1 except that the thickness of the pressure-sensitive adhesive layer was changed to 45 μm, and the thickness of the base layer was changed to 160 μm.

### Example 5

A mixture of 90 parts of an amorphous propylene-(1-butene) copolymer polymerized by using the metallocene catalyst (manufactured by Sumitomo Chemical Co., Ltd., product name “Tafseren H5002”: constituent unit derived from propylene: 90 mol %/constituent unit derived from 1-butene: 10 mol %, Mw=230,000, Mw/Mn=1.8) and 10 parts of a crystalline polypropylene-based resin polymerized by using the metallocene catalyst (manufactured by Japan Polypropylene Corporation, product name “WINTEC WFX4, ” Mw=363,000, Mw/Mn=2.87) was used as the pressure-sensitive adhesive layer-forming material.

An ethylene-vinyl acetate copolymer (manufactured by DU PONT-MITSUI POLYCHEMICALS, product name “Evaflex P-1007”) was used as the base layer-forming material.

The pressure-sensitive adhesive layer-forming material (100 parts) and the base layer-forming material (100 parts) described above were separately fed into extruders to perform T-die melt-coextrusion (extruder: manufactured by GM ENGINEERING, Inc., product name “GM 30-28”/T-die: feed-block system; extrusion temperature: 180° C.), and the molten resins and an Si-coated PET separator (manufactured by Mitsubishi Chemical Corporation, product name “Diafoil MRF”: 38 μm), which was delivered to a touch roll molding part, were laminated, followed by cooling, to thereby obtain a pressure-sensitive adhesive tape including a pressure-sensitive adhesive layer with a thickness of 45 μm and a base layer with a thickness of 85 μm.

### Example 6

A pressure-sensitive adhesive tape was obtained in the same manner as in Example 5 except that the thickness of the base layer was changed to 160 μm.

### Example 7

A pressure-sensitive adhesive tape was obtained in the same manner as in Example 5 except that the amounts of the amorphous propylene-(1-butene) copolymer and crystalline polypropylene-based resin mixed in the pressure-sensitive adhesive layer-forming material were changed by using 80 parts of the amorphous propylene-(1-butene) copolymer instead of 90 parts of the amorphous propylene-(1-butene) copolymer and by using 20 parts of the crystalline polypropylene-based resin instead of 10 parts of the crystalline polypropylene-based resin.

### Example 8

A pressure-sensitive adhesive tape was obtained in the same manner as in Example 5 except that the amounts of the amorphous propylene-(1-butene) copolymer and crystalline polypropylene-based resin mixed in the pressure-sensitive adhesive layer-forming material were changed by using 80 parts of the amorphous propylene-(1-butene) copolymer instead of 90 parts of the amorphous propylene-(1-butene) copolymer and by using 20 parts of the crystalline polypropylene-based resin instead of 10 parts of the crystalline polypropylene-based resin, and the thickness of the base layer was changed to 160 μm.

### Example 9

A mixture of 90 parts of an amorphous propylene-(1-butene) copolymer polymerized by using the metallocene catalyst (manufactured by Sumitomo Chemical Co., Ltd., product name “Tafseren H5002”: constituent unit derived from propylene: 90 mol %/constituent unit derived from 1-butene: 10 mol %, Mw=230,000, Mw/Mn=1.8) and 10 parts of a crystalline polypropylene-based TPO resin polymerized by using the metallocene catalyst (manufactured by Japan Polypropylene Corporation, product name “WELNEX RFG4VA”) was used as the pressure-sensitive adhesive layer-forming material.

An ethylene-vinyl acetate copolymer (manufactured by DU PONT-MITSUI POLYCHEMICALS, product name “Evaflex P-1007”) was used as the base layer-forming material.

The pressure-sensitive adhesive layer-forming material (100 parts) and the base layer-forming material (100 parts) described above were separately fed into extruders to perform T-die melt-coextrusion (extruder: manufactured by GM ENGINEERING, Inc., product name “GM 30-28”/T-die: feed-block system; extrusion temperature: 180° C.), and the molten resins and an Si-coated PET separator (manufactured by Mitsubishi Chemical Corporation, product name “Diafoil MRF”: 38 μm), which was delivered to a touch roll molding part, were laminated, followed by cooling, to thereby obtain a pressure-sensitive adhesive tape including a pressure-sensitive adhesive layer with a thickness of 45 μm and a base layer with a thickness of 85 μm.

### Example 10

A pressure-sensitive adhesive tape was obtained in the same manner as in Example 9 except that thickness of the base layer was changed to 160 μm.

### Example 11

A pressure-sensitive adhesive tape was obtained in the same manner as in Example 9 except that the amounts of the amorphous propylene-(1-butene) copolymer and crystalline polypropylene-based TPO resin mixed in the pressure-sensitive adhesive layer-forming material were changed by using 80 parts of the amorphous propylene-(1-butene) copolymer instead of 90 parts of the amorphous propylene-(1-butene) copolymer and by using 20 parts of the crystalline polypropylene-based TPO resin instead of 10 parts of the crystalline polypropylene-based TPO resin.

### Example 12

A pressure-sensitive adhesive tape was obtained in the same manner as in Example 9 except that the amounts of the amorphous propylene-(1-butene) copolymer and crystalline polypropylene-based TPO resin mixed in the pressure-sensitive adhesive layer-forming material were changed by using 80 parts of the amorphous propylene-(1-butene) copolymer instead of 90 parts of the amorphous propylene-(1-butene) copolymer and by using 20 parts of the crystalline polypropylene-based TPO resin instead of 10 parts of the crystalline polypropylene-based TPO resin, and the thickness of the base layer was changed to 160 μm.

### Comparative Example 1

A pressure-sensitive adhesive tape was obtained in the same manner as in Example 1 except that a thermoplastic acrylic polymer (manufactured by Kuraray Co., Ltd., product name “LA 2140e”: Mw=74,000, Mw/Mn=1.3) was used instead of the amorphous propylene-(1-butene) copolymer polymerized by using the metallocene catalyst.

### Comparative Example 2

A pressure-sensitive adhesive tape was obtained in the same manner as in Example 1 except that a thermoplastic acrylic polymer (manufactured by Kuraray Co., Ltd., product name “LA2250”: Mw=64,000, Mw/Mn=1.1) was used instead of the amorphous propylene-(1-butene) copolymer polymerized by using the metallocene catalyst.

### Reference Example 1

A mixture of 80 parts of an amorphous propylene-(1-butene) copolymer polymerized by using the metallocene catalyst (manufactured by Sumitomo Chemical Co., Ltd., product name “Tafseren H5002”: constituent unit derived from propylene:90mol %/constituent unit derived from 1-butene: 10 mol %, Mw=230,000, Mw/Mn=1.8) and 20 parts of a crystalline polypropylene-based resin polymerized by using a Ziegler-Natta catalyst (manufactured by Sumitomo Chemical Co., Ltd., product name “NOBLEN FL331G5”) was used as the pressure-sensitive adhesive layer-forming material.

An ethylene-vinyl acetate copolymer (manufactured by DU PONT-MITSUI POLYCHEMICALS, product name “Evaflex P-1007”) was used as the base layer-forming material.

The pressure-sensitive adhesive layer-forming material (100 parts) and the base layer-forming material (100 parts) described above were separately fed into extruders to perform T-die melt-coextrusion (temperature: 180° C.), and the molten resins and an Si-coated PET separator (manufactured by Mitsubishi Chemical Corporation, product name “Diafoil MRF”: 38 μm), which was delivered to a touch roll molding part, were laminated, followed by cooling, to thereby obtain a pressure-sensitive adhesive tape including a pressure-sensitive adhesive layer with a thickness of 30 μm and a base layer with a thickness of 100 μm.

[Evaluation]

The shear viscosities of the pressure-sensitive adhesive layer-forming materials and base layer-forming materials used in Examples and Comparative Examples were evaluated by the following method. Table 1 shows the results.

### (1) Shear Viscosity

A resin was filled into a twin capillary extensional rheometer (manufactured by ROSAND Precision Ltd.: RH7-2 twin capillary rheometer) equipped with a barrel and dies adjusted to 180° C. Measurement was performed using a device including a main die (diameter: 2 mm, length: 20 mm) and a sub die (diameter: 2 mm, length: 1 mm or less) with Bagley correction at a predetermined shear rate region of 2 to 1,000 sec⁻¹ to create a shear rate-shear viscosity curve. The resin viscosity (Pa·s) at a shear rate of 100 sec⁻¹ was defined as a shear viscosity.

The pressure-sensitive adhesive tapes obtained in Examples and Comparative Examples were subjected to the following evaluation. Table 1 shows the results.

(2) Adhesion (Peeling Rate: 300 mm/min)

The resultant pressure-sensitive adhesive tapes were aged at 50° C. for two days, and their adhesions were each measured on a mirror surface of a 4-inch semiconductor wafer (made of silicon) by a method according to JIS 2.0237 (2000) (attaching conditions: turning a 2-kg roller one round, peeling rate: 300 mm/min, peeling angle: 180°).

### (3) Contamination Property

The pressure-sensitive adhesive tapes were each attached on a mirror surface of a 4-inch semiconductor wafer and peeled off after a lapse of one hour under an environment of a temperature of 23° C. and a relative humidity of 50%, and the number of particles having particle sizes of 0.28 μm or more on the mirror surface was measured. The number of the particles was measured using a particle counter (manufactured by KLA-Tencor Corporation, product name “SURFSCAN 6200”).

Amounts of ions in the pressure-sensitive adhesive layers formed in Examples and Comparative Examples were measured by the following method. Table 1 shows the results.

### (4) Amount of Ion in Pressure-Sensitive Adhesive Layer

Amounts of analyte ions (F⁻, Br⁻, NO₂⁻, NO₃⁻, SO₄²⁻, Li⁺, Na⁺, K⁺, Mg²⁺, Ca²⁺, and NH₄⁺) in the pressure-sensitive adhesive layers were measured by ion chromatography.

Specifically, a test specimen (1 g of the pressure-sensitive adhesive-forming material) placed in a polymethylpentene (PMP) container was weighed, and 50 ml of pure water were added thereto. Then, the container was covered with a lid and placed in a drying machine to perform heating extraction at 120° C. for 1 hour. The extract was filtrated using a cartridge for sample pretreatment (manufactured by DIONEX, product name “On Guard II RP”), and the filtrate was subjected to measurement by ion chromatography (anion) (manufactured by DIONEX, product name “DX-320”) and by ion chromatography (cation) (manufactured by DIONEX, product name “DX-500”). Detection limits of this measurement method were found to be 0.49 μg or less for each of F⁻, Cl⁻, Br⁻, NO₂⁻, NO₃⁻, SO₄²⁻, and K⁺, 0.20 μg or less for each of Li⁺ and Na⁺, 0.97 μg or less for each of Mg²⁺ and Ca²⁺, and 0.50 μg or less for NH₄⁺ with respect to 1 g of the pressure-sensitive adhesive-forming material.

(5) Processability

Processability in the coextrusion molding in Examples and Comparative Examples were evaluated by the following criteria. Table 1 shows the results.

×: The base layer resin and pressure-sensitive adhesive layer resin are segregated on the end of the molten film where the pressure-sensitive adhesive resin has been extruded by an encapsulation phenomenon, and appearance failures such as wave marks due to confluence failures are caused.

Δ: Appearance failures such as wave marks due to confluence failures of the base layer resin and the pressure-sensitive adhesive layer resin are caused.

∘: The above-mentioned failures in molding are not caused.

(6) Measurement of Molecular Weight

The molecular weight of each of the amorphous propylene-(1-butene) copolymer polymerized by using the metallocene catalyst (manufactured by Sumitomo Chemical Co., Ltd., product name “Tafseren H5002”) used in each of Examples and Comparative Example 3, the thermoplastic acrylic polymer (manufactured by Kuraray Co., Ltd., product name “LA 2140e”) used in Comparative Example 1, and the thermoplastic acrylic polymer (manufactured by Kuraray Co., Ltd., product name “LA 2250”) used in Comparative Example 2 was measured as follows. That is, a sample (1.0 g/1 THF solution) was prepared, allowed to stand still overnight, and filtrated using a membrane filter with a pore size of 0.45 μm, and the resultant filtrate was subjected to measurement using HLC-8120 GPC manufactured by TOSOH Corporation under the following conditions. The molecular weight was calculated in terms of polystyrene.
Column: TSKgel Super HZM-H/HZ4000/HZ3000/HZ2000
Column size: 6.0 mm I.D.'150 mm
Column temperature: 40° C.
Eluent: THF
Flow rate: 0.6 ml/min
Injection amount: 20 μl
Detector: refractive index detector (RI)

Meanwhile, the molecular weight of the crystalline polypropylene-based resin polymerized by using the metallocene catalyst (manufactured by Japan Polypropylene Corporation, product name “WINTEC WFX4”) used in each of Examples 5 to 8 was measured as follows. That is, a sample (0.10% (w/w) o-dichlorobenzene solution) was prepared and dissolved at 140° C., and the solution was filtrated by a sintered filter with a pore size of 1.0 μm. The resultant filtrate was subjected to measurement by a gel permeation chromatograph Alliance GPC type 2000 manufactured by Waters under the following conditions. The molecular weight was calculated in terms of polystyrene.
Column: TSKgel GMH₆-HT, TSKgel GMH₆-HTL
Column size: two columns of 7.5 mm I.D.×300 mm size for each type
Column temperature: 140° C.
Eluent: o-dichlorobenzene
Flow rate: 1.0 ml/min
Injection amount: 0.4 ml
Detector: refractive index detector (RI)

TABLE 1

| | | | Example 1 | Example 2 | Example 3 | Example 4 | Example 5 | Example 6 | Example 7 | Example 8 | Example 9 |
|---|---|---|---|---|---|---|---|---|---|---|---|
| Base | Material name | | P-1007 | P-1007 | P-1007 | P-1007 | P-1007 | P-1007 | P-1007 | P-1007 | P-1007 |
| layer | Thickness (μm) | | 100 | 85 | 175 | 160 | 85 | 160 | 85 | 160 | 85 |
| Pressure- | Material | Main resin | H5002 | H5002 | H5002 | H5002 | H5002 | H5002 | H5002 | H5002 | H5002 |
| sensitive | name | Additional | — | — | — | — | WFX4 | WFX4 | WFX4 | WFX4 | RFG4VA |
| adhesive | | resin | | | | | | | | | |

| | | | | | | | | | | |
|---|---|---|---|---|---|---|---|---|---|---|
| layer | Mix ratio (main | — | — | — | — | 90/10 | 90/10 | 80/20 | 80/20 | 90/10 |
| | resin/additional | | | | | | | | | |
| | resin = wt %/wt %) | | | | | | | | | |
| | Thickness (μm) | 30 | 45 | 30 | 45 | 45 | 45 | 45 | 45 | 45 |
| Shear | Base layer A | 370 | 370 | 370 | 370 | 370 | 370 | 370 | 370 | 370 |
| viscos- | (Pa · s) at 100 (1/s) | | | | | | | | | |
| ity | Pressure-sensitive | 730 | 730 | 730 | 730 | 800 | 800 | 850 | 850 | 810 |
| | adhesive layer B | | | | | | | | | |
| | (Pa · s) at 100 (1/s) | | | | | | | | | |
| | Shear viscosity | 360 | 360 | 360 | 360 | 430 | 430 | 480 | 480 | 440 |
| | difference (B − A) | | | | | | | | | |
| | (Pa · s) at 100 (1/s) | | | | | | | | | |
| Evalua- | Adhesion | 1.09 | 1.36 | 1.1 | 1.22 | 0.65 | 0.67 | 0.52 | 0.55 | 0.7 |
| tion | (N/20 mm) | | | | | | | | | |
| | Contamination property | 3.55 | 3.76 | 12.8 | 12.7 | 4.5 | 11.9 | 4.8 | 11.6 | 5.5 |
| | (number of particles) | | | | | | | | | |
| | (particles/cm²) | | | | | | | | | |
| | Ion amount Ion species: | — | — | — | — | — | — | — | — | — |
| | amount of ion detected | | | | | | | | | |
| | (Ion species detected | | | | | | | | | |
| | and the amount of the | | | | | | | | | |
| | ion detected are shown. | | | | | | | | | |
| | In the case where amounts | | | | | | | | | |
| | of all target ions are | | | | | | | | | |
| | smaller than detection | | | | | | | | | |
| | limits, the results are | | | | | | | | | |
| | shown by “—”.) | | | | | | | | | |
| | Processability | ∘ | ∘ | ∘ | ∘ | ∘ | ∘ | ∘ | ∘ | ∘ |

| | | | | | | Comparative | Comparative | Reference |
|---|---|---|---|---|---|---|---|---|
| | | | Example 10 | Example 11 | Example 12 | Example 1 | Example 2 | Example 1 |
| Base | Material name | | P-1007 | P-1007 | P-1007 | P-1007 | P-1007 | P-1007 |
| layer | Thickness (μm) | | 160 | 85 | 160 | 100 | 100 | 100 |
| Pressure- | Material | Main resin | H5002 | H5002 | H5002 | LA2140e | LA2250 | H5002 |
| sensitive | name | Additional | RFG4VA | RFG4VA | RFG4VA | — | — | FL331G5 |
| adhesive | | resin | | | | | | |

| | | | | | | | |
|---|---|---|---|---|---|---|---|
| layer | Mix ratio (main | 90/10 | 80/20 | 80/20 | 100/0 | 100/0 | 80/20 |
| | resin/additional | | | | | | |
| | resin = wt %/wt %) | | | | | | |
| | Thickness (μm) | 45 | 45 | 45 | 30 | 30 | 30 |
| Shear | Base layer A | 370 | 370 | 370 | 370 | 370 | 370 |
| viscos- | (Pa · s) at 100 (1/s) | | | | | | |
| ity | Pressure-sensitive | 810 | 840 | 840 | 243 | 394 | 860 |
| | adhesive layer B | | | | | | |
| | (Pa · s) at 100 (1/s) | | | | | | |
| | Shear viscosity | 440 | 470 | 470 | −127 | 24 | 490 |
| | difference (B − A) | | | | | | |
| | (Pa · s) at 100 (1/s) | | | | | | |
| Evalua- | Adhesion | 0.68 | 0.52 | 0.54 | 1.99 | 0.61 | 0.35 |
| tion | (N/20 mm) | | | | | | |
| | Contamination property | 13.1 | 5.3 | 12.8 | 66.6 | 98.7 | 101 |
| | (number of particles) | | | | | | |
| | (particles/cm²) | | | | | | |
| | Ion amount Ion species: | — | — | — | Cl⁻: 2.3 | Li⁺: 0.7 | Cl⁻: 1.3 |
| | amount of ion detected | | | | | | Ca²⁺: 1.6 |
| | (Ion species detected | | | | | | |
| | and the amount of the | | | | | | |
| | ion detected are shown. | | | | | | |
| | In the case where amounts | | | | | | |
| | of all target ions are | | | | | | |
| | smaller than detection | | | | | | |
| | limits, the results are | | | | | | |
| | shown by “—”.) | | | | | | |
| | Processability | ∘ | ∘ | ∘ | x | ∘ | ∘ |

As is clear from Examples, according to the present invention, it is possible to provide a pressure-sensitive adhesive tape which causes less contamination to an adherend and is excellent in both adhesion and peeling property because the tape includes a specific amorphous propylene-(1-butene) copolymer polymerized by using the metallocene catalyst.

In addition, the pressure-sensitive adhesive tapes obtained in Examples have excellent processability even if feed-block-system T-dies inferior in moldability to multi-manifold-system T-dies are used by appropriately controlling the shear viscosities of the base layer and pressure-sensitive adhesive layer.

The pressure-sensitive adhesive tape of the present invention can be suitably used in, for example, the protection a workpiece (such as a semiconductor wafer) upon production of a semiconductor apparatus.

What is claimed is:

1. A pressure-sensitive adhesive tape, comprising:
a pressure-sensitive adhesive layer; and
a base layer, wherein:
the pressure-sensitive adhesive layer contains an amorphous propylene-(1-butene) copolymer polymerized by using a metallocene catalyst, the amorphous propylene-(1-butene) copolymer having a weight-average molecular weight (Mw) of 200,000 or more and a molecular weight distribution (Mw/Mn) of 2 or less; and
the base layer contains an ethylene-vinyl acetate copolymer.

2. A pressure-sensitive adhesive tape according to claim 1, wherein the pressure-sensitive adhesive layer is substantially free of F⁻, Br⁻, NO₂⁻, NO₃⁻, SO₄²⁻, Li⁺, Na⁺, K⁺, Mg²⁺, Ca²⁺, and NH₄⁺.

3. A pressure-sensitive adhesive tape according to claim 1, wherein a content of a constituent unit derived from 1-butene in the propylene-(1-butene) copolymer is 1 mol % to 15 mol %.

4. A pressure-sensitive adhesive tape according to claim 1, which is obtained by coextrusion molding of a pressure-sensitive adhesive layer-forming material and a base layer-forming material.

5. A pressure-sensitive adhesive tape according to claim 4, wherein a difference “pressure-sensitive adhesive layer-forming material-base layer-forming material” in shear viscosity of the pressure-sensitive adhesive layer-forming material and the base layer-forming material at a temperature of 180° C. and a shear rate of 100 sec⁻¹ is −150 Pa·s to 600 Pa·s or less.

6. A pressure-sensitive adhesive tape according to claim 1, wherein the pressure-sensitive adhesive tape is used for processing a semiconductor wafer.
